(19) United States
(12) Patent Application Publication
(10) Pub. No.: US 2026/0016416 A1
(43) Pub. Date: Jan. 15, 2026

(54) QUANTITATIVE PHASE IMAGING OF CELLULAR DYNAMICS AND MOLECULAR CHARACTERIZATION

(71) Applicant: The Board of Trustees of the University of Illinois, Urbana, IL (US)

(72) Inventors: Yang Liu, Champaign, IL (US); Hongqiang Ma, Sewickley, PA (US)

(21) Appl. No.: 19/267,367

(22) Filed: Jul. 11, 2025

Related U.S. Application Data
(60) Provisional application No. 63/670,569, filed on Jul. 12, 2024.

(51) Int. Cl. G01N 21/64

(52) U.S. Cl. CPC G01N 21/6486; G01N 21/6458; G01N 2021/6471; G01N 2021/6478; G01N 2201/126; G01N 2201/127

(57) ABSTRACT

Mesoscopic imaging systems and methods comprise or utilize a light source configured to generate an illumination light; an optical system configured to direct the illumination light toward a sample; an objective lens having a numerical aperture (NA) of 0.2 to 0.6, the objective lens being configured to receive a response light emitted by the sample in response to the illumination light; a filter wheel comprising a plurality of emission filters configured to filter the response light to generate a filtered light; a tube lens configured to provide an optical magnification to the filtered light; and an image sensor having 40 megapixels or more and a pixel size of less than or equal to 4 μm, the image sensor being configured to receive the filtered light and generate image data based on the received filtered light.

### CROSS-REFERENCE TO RELATED APPLICATIONS

This application claims priority to and the benefit of U.S. Provisional Application No. 63/670,569, filed Jul. 12, 2024 and titled “Omni-Mesoscope for Multiscale High-throughput Quantitative Phase Imaging of Cellular Dynamics and High-content Molecular Characterization,” the entire contents of which are herein incorporated by reference for all purposes.

### STATEMENT OF FEDERALLY SPONSORED RESEARCH

This invention was made with government support under R01 CA232593, R01 CA254112, and R21 CA259787 awarded by the National Institutes of Health. The government has certain rights in the invention.

### BACKGROUND

The mesoscope, having capacity to capture vast cell populations using a single expansive field of view, is an imaging tool in biomedical research, despite its high cost and bulky physical footprint in comparative examples. Examples of the present disclosure include the Omni-Mesoscope, a high-spatial-temporal, multimodal, and multiplex mesoscopic imaging platform built from cost-efficient components. In certain examples, the system integrates quantitative phase imaging for label-free live-cell analysis and cyclic highly multiplexed fluorescence imaging for high-content molecular profiling. Systems and methods in accordance with the present disclosure enable non-invasive tracking of morphodynamics across thousands of cells concurrently, coupled with in-depth molecular characterization at the single-cell level.

### SUMMARY OF THE DISCLOSURE

According to an aspect of the present disclosure, a mesoscope is provided. The mesoscope comprises a light source configured to generate an illumination light; an optical system configured to direct the illumination light toward a sample; an objective lens having a numerical aperture (NA) of 0.2 to 0.6, the objective lens being configured to receive a response light emitted by the sample in response to the illumination light; a filter wheel comprising a plurality of emission filters configured to filter the response light to generate a filtered light; a tube lens configured to provide an optical magnification to the filtered light; and an image sensor having 40 megapixels or more and a pixel size of less than or equal to 4 μm, the image sensor being configured to receive the filtered light and generate image data based on the received filtered light.

According to another aspect of the present disclosure, an imaging method is provided. The method comprises capturing image data using a mesoscope, the mesoscope including a light source configured to generate an illumination light, an optical system configured to direct the illumination light toward a sample, an objective lens having a numerical aperture (NA) of 0.2 to 0.6, the objective lens being configured to receive a response light emitted by the sample in response to the illumination light, a filter wheel comprising a plurality of emission filters configured to filter the response light to generate a filtered light, a tube lens configured to provide an optical magnification to the filtered light, and an image sensor having 40 megapixels or more and a pixel size of less than or equal to 4 μm, the image sensor being configured to receive the filtered light and generate image data based on the received filtered light; and transmitting the image data to a controller, the controller including a processor and a memory.

### BRIEF DESCRIPTION OF THE DRAWINGS

FIG. 1A illustrates an example schematic of a microscope system according to various aspects of the present disclosure.

FIG. 1B illustrates an example perspective view of a microscope system according to various aspects of the present disclosure.

FIG. 1C illustrates an example of imaging characteristics according to various aspects of the present disclosure.

FIG. 2 illustrates an example performance evaluation according to various aspects of the present disclosure.

FIG. 3 illustrates an example performance evaluation according to various aspects of the present disclosure.

FIG. 4 illustrates example images according to various aspects of the present disclosure.

FIG. 5A illustrates an example performance evaluation according to various aspects of the present disclosure.

FIG. 5B illustrates an example performance evaluation according to various aspects of the present disclosure.

FIG. 6 illustrates example images according to various aspects of the present disclosure.

FIG. 7 illustrates example images according to various aspects of the present disclosure.

FIG. 8A illustrates an example performance evaluation according to various aspects of the present disclosure.

FIG. 8B illustrates an example performance evaluation according to various aspects of the present disclosure.

FIG. 9A illustrates example analyses according to various aspects of the present disclosure.

FIG. 9B illustrates example analyses according to various aspects of the present disclosure.

FIG. 9C illustrates example analyses according to various aspects of the present disclosure.

FIG. 10 illustrates example images according to various aspects of the present disclosure.

FIG. 11 illustrates example images according to various aspects of the present disclosure.

FIG. 12 illustrates example images according to various aspects of the present disclosure.

FIG. 13 illustrates example images according to various aspects of the present disclosure.

FIG. 14A illustrates an example image processing technique according to various aspects of the present disclosure.

FIG. 14B illustrates an example image processing technique according to various aspects of the present disclosure.

FIG. 14C illustrates an example image processing technique according to various aspects of the present disclosure.

FIG. 15 illustrates an example imaging method according to various aspects of the present disclosure.

### DETAILED DESCRIPTION

Described here are systems and methods for imaging. While various examples and use cases will be described, the systems and methods set forth herein may be applied in a range of technological fields, including but not limited to medical diagnostics, therapy evaluation, pharmaceutical research, biological and medical sciences research, plant and crop research, materials, solid-state physics, or any other technological field in which optical microscopy may be implemented.

The present technology will now be described more fully with reference to the accompanying drawings, in which some, but not all, embodiments are shown. Indeed, the technology may be embodied in many different forms and should not be construed as limited to the embodiments set forth herein; rather, these embodiments are provided so that this disclosure will satisfy applicable legal requirements.

Likewise, many modifications and other embodiments of the technology described herein will come to mind to one of skill in the art to which the invention pertains having the benefit of the teachings presented in the following descriptions and the associated drawings. Therefore, it is to be understood that the disclosure is not to be limited to the specific embodiments disclosed and that modifications and other embodiments are intended to be included within the scope of the disclosure. Although specific terms are employed herein, they are used in a generic and descriptive sense only and not for purposes of limitation. Unless defined otherwise, all technical and scientific terms used herein have the same meaning as commonly understood by one of skill in the art to which the technology pertains.

Throughout the specification and claims, terms may have meanings suggested or implied in context beyond an explicitly stated meaning. Likewise, the phrases “in one embodiment,” “in one example, “in one aspect,” or “in one implementation” as used herein do not necessarily refer to the same embodiment, example, aspect, or implementation; and the phrases “in another embodiment,” “in another example,” “in another aspect,” or “in another implementation” as used herein do not necessarily refer to a different embodiment, example, aspect, or implementation. It is intended, for example, that the claimed subject matter includes combinations of exemplary embodiments, examples, aspects, or implementations in whole or in part.

In general, terminology may be understood at least in part from usage in context. For example, terms such as “and,” “or,” or “and/or” as used herein may include a variety of meanings that may depend at least in part upon the context in which such terms are used. For example, the use of “or” to associate a list, such as “A, B, or C” is intended to mean “A, B, and C,” here used in the inclusive sense, as well as “A, B, or C,” here used in the exclusive sense. IN addition, the phrase “one or more” or “at least one” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” or “determined by” may be understood as not necessarily intended to convey an exclusive set of factors and may, instead, allow for the existence of additional factors not necessarily expressly described, again, depending at least in part on context. Unless defined otherwise, all technical and scientific terms used herein have the same meaning as commonly understood by one of skill in the art to which the invention pertains.

Biological systems are characterized by substantial cellular and molecular heterogeneity, functioning within diverse microenvironments across various timescales. Addressing this complexity requires technologies capable of simultaneously capturing both the behaviors and molecular characteristics of individual cells over time across a large cell population in their spatial context at a high temporal and spatial resolution. Such a high-throughput high- resolution imaging system is may identify dynamic, rare events coupled with detailed subcellular and molecular characteristics, thereby facilitating in-depth analysis of diverse cellular phenotypes. This multiscale multifunctional imaging approach may be used to reveal the mechanisms underlying therapeutic response from a systems-to-molecular perspective and in to identify effective diagnostic or prognostic biomarkers.

Comparative imaging systems are often limited by a trade-off between the field of view (FOV) and image resolution, significantly hindering the ability to simultaneously observe cellular dynamics with the necessary subcellular details across a large cell population. Mesoscopic imaging technology may provide a FOV spanning several millimeters. However, comparative mesoscopic systems are limited to a resolution of several micrometers because of various factors such as numerical aperture (NA), optical aberrations, magnification, and image sensors. Although comparative mesoscope designs may observe cell dynamics over a large cell population, their limited resolution hampers the visualization of the subcellular details. Some comparative systems have attempted to enhance spatial resolution by utilizing specially designed mesoscopic objective lenses with a higher NA up to 0.47 (e.g., mesolenses), along with camera/detector arrays to increase the curved FOV, but these comparative systems are hindered by the complexity and cost of manufacturing such systems, which may be prohibitive. Moreover, a comparative mesoscope relies on a few fluorescent markers, which can perturb the natural state of cells, thus limiting the capacity for long-term observation of live-cell dynamics with rich functional insights. In view of these and other shortcomings in comparative systems, there exists need in the art for an advanced multimodal imaging solution that can overcome these limitations to observe cell dynamics at a high spatiotemporal resolution over a large cell population without sacrificing in-depth functional information.

Thus, the present disclosure provides, in examples, a versatile and cost-effective multimodal mesoscopic imaging system (referred to herein as an “Omni-Mesoscope”) that achieves a sub-micrometer spatial resolution (e.g., down to 700 nm) across a wide FOV, ˜5 mm², at a speed of 4 frames per second, which may be a result of limitations in the camera speed. The Omni-Mesoscope couples quantitative phase microscopy for label-free live-cell imaging with highly multiplex fluorescence microscopy for high-content functional imaging. This integration allows for continuous monitoring of live-cell dynamics alongside detailed molecular analysis on the same cells over a large cell population, providing a comprehensive view of large-scale dynamic cellular processes and their underlying molecular characteristics. The capability of Omni-Mesoscope to identify rare cell behaviors in response to chemotherapy drugs, which are linked to their underlying molecular characteristics, has been demonstrated. Furthermore, by incorporating expansion microscopy, the potential of Omni-Mesoscope for three-dimensional (3D) volumetric super-resolution imaging of thick tissue across the mesoscale has been demonstrated. This imaging system not only overcomes the limitations of comparative techniques but also opens avenues for exploring the complexities of biological systems at unprecedented scales and resolutions.

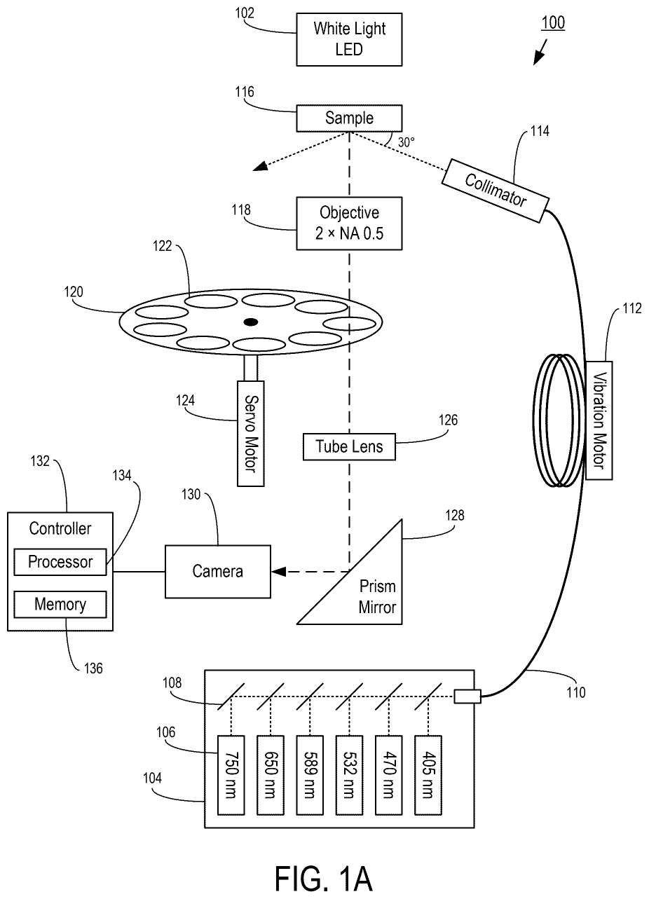

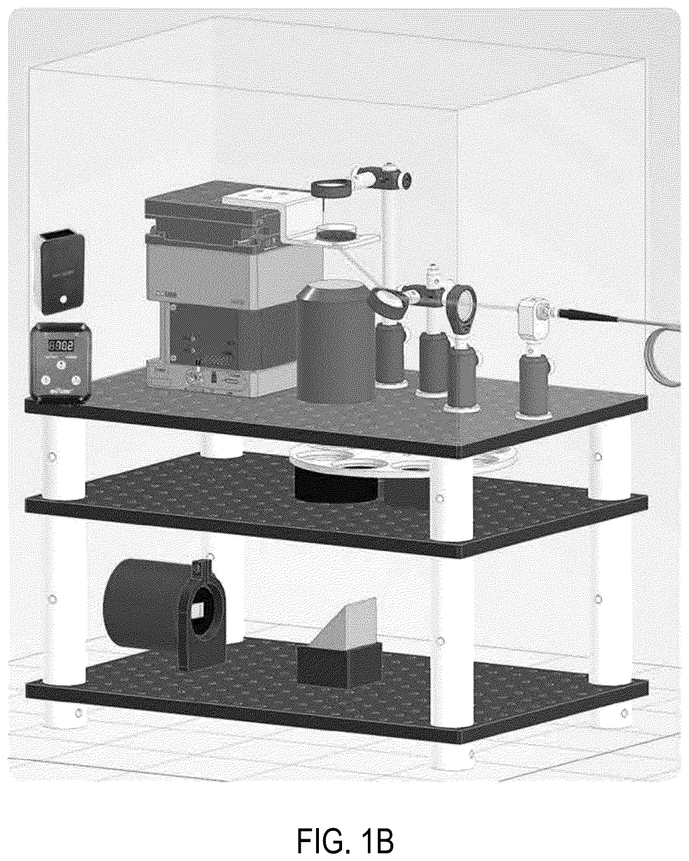

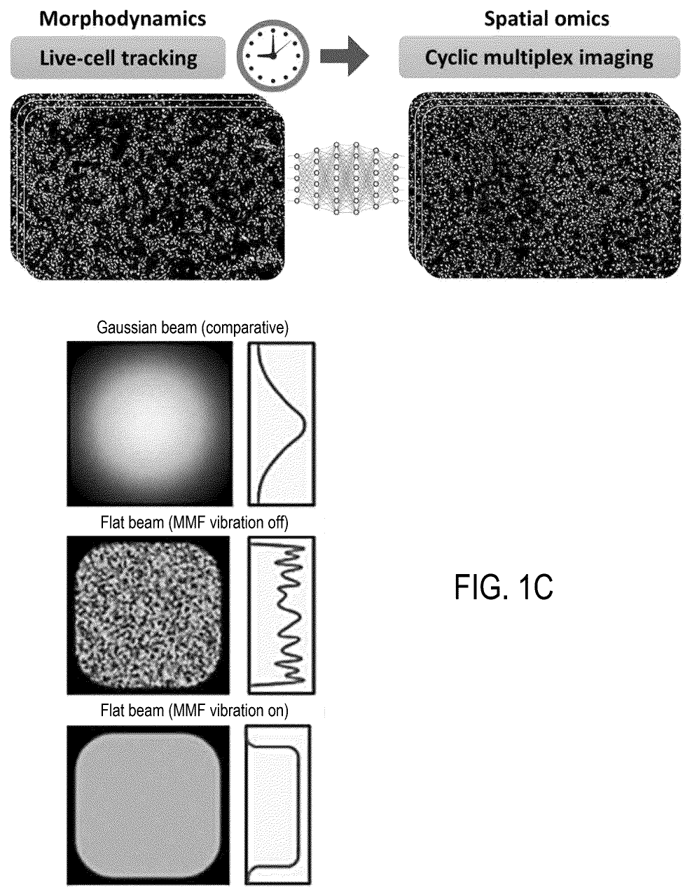

In examples, the Omni-Mesoscope may be implemented as automated imaging system with two imaging modalities: label-free quantitative phase imaging module implemented via transport of intensity equation (TIE)-based phase retrieval and highly multiplex fluorescence imaging module implemented with a flat-field illumination and multispectral detection. An example schematic of the Omni-Mesoscope system 100 is shown in FIG. 1A. The system 100 includes a white-light (WL) light emitting diode (LED) 102 to provide a WL illumination beam for quantitative phase imaging. A laser system 104 comprising six diode lasers 106 emitting at different peak wavelengths (in the example, emitting at wavelengths of 405, 470, 530, 589, 650, and 750 nm, respectively) and six dichroic mirrors 108 is optically coupled to a multimode (MM) fiber (MMF) 110 equipped with a high-frequency vibration motor 112 to create uniform flat-field illumination. However, the laser system 104 is not limited to six diode lasers 106, and in other implementations may use any number of light emitting elements, which may be diode lasers or other light emitting devices. The illumination light, collimated by collimator 114, is obliquely introduced from the bottom of the sample 116 with an incident angle that is greater than the maximum collection angle of an objective lens that is included in a first optical system 118, which decouples from the detection path. By introducing the illumination light at such an angle, the illumination light is reflected outside the collection cone of the objective, preventing it from being captured. This may reduce background signal and improve image contrast. In the illustrated example, this incident angle is 60° relative to the sample surface normal (30° relative to the surface plane). Light from the sample 116 passes through the first optical system 118 and is filtered by a motorized filter wheel 120 having a plurality (in the illustrated example, nine) of band-pass emission filters 122 corresponding to different pass bands, the filter wheel 120 being controlled by a servo motor 124, for multiplex fluorescence imaging. After filtering, the light passes through a second optical system 126 and is redirected by an optional prism mirror 128 toward a camera 130. FIG. 1B shows an example rendering of the system 100, whereas FIG. 1C shows optical effects including the beam profile.

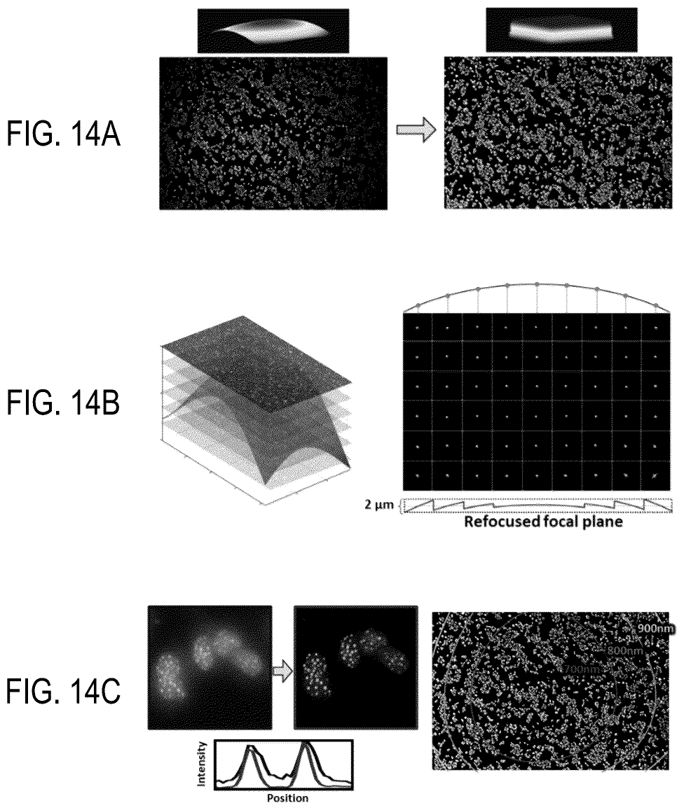

The camera 130 generates an image based on the light received. In the illustrated example of FIG. 1A, the camera 130 is connected to a controller 132 (e.g., a computing device, such as a laptop computer, a desktop computer, a smartphone, a tablet computer, etc.), which includes a processor 134 and a memory 136. The controller 132 may be a separate device from the camera 130 and connected thereto by a wired or wireless connection. In such examples, the controller 132 may be a local device (e.g., a device operating in the same lab or room as the system 100, or a device connected to the same local network as the system 100) or a remote device (e.g., a cloud computing server). In other examples, however, the camera 130 and the controller 132 may be part of the same device. In examples, the controller 132 is configured to process image data received from the camera 130 by performing an image processing operation, such as one or more of the operations described in more detail below with regard to FIGS. 14A-14C.

As used herein, the term “processor” may include one or more processors and memories and/or one or more programmable hardware elements. As used herein, a “processor” may include one or more individual processing units and/or one or more individual processing cores. Where a processor is referred to as performing a method or operation, various procedures, sub-operations, steps, etc. may be performed by the same processing unit/core and/or by different processing units/cores, in series or in parallel, in any combination. As used herein, the term “processor” is intended to include any of types of processors, central processing units (CPUs), graphics processing units (GPUs), microcontrollers, digital signal processors, or other devices capable of executing software instructions. For the avoidance of doubt, cloud processing is contemplated in the definition of a processor.

As used herein, the term “memory” includes a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; or an installation medium, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory.

The system 100 achieves an ultra-large FOV at a high resolution through the combination of hardware elements illustrated in FIG. 1A. The first optical system 118 may adopt an off-the-shelf objective lens (MVPLAPO 2 XC, Olympus) at an NA of 0.2-0.6 (e.g., 0.5), originally designed for a stereomicroscope with a FOV of centimeters. The camera 130 may utilize a large-format image sensor with tens of megapixels and a small pixel size, implemented with a cost-effective astronomy camera (ASI294MM pro, ZWO) that has a large-format sensor of 40 MP or more (e.g., IMX 492, ˜50 megapixels, approximately an order of magnitude more than scientific complementary metal-oxide semiconductor (sCMOS), and a small pixel size of less than 4 μm (e.g., ˜2.3 μm). A comparison of the image sensor used in the example system 100 with a comparative sCMOS sensor is presented in Table 1. The second optical system 126 may include a macro lens (DCR-5320 Pro, Raynox) generally used for photography as a tube lens to achieve an optical magnification. The amount of optical magnification may be based on the target optical resolution. In the illustrated example, the target optical resolution is ˜700 nm which, according to the Nyquist sampling criterion, leads to an effective sampling interval of less than 350 nm. As a result, the illustrated example uses a magnification of ˜7×, resulting in a sampling size of ˜320 nm when using a camera with a pixel size of ˜2.3 μm. In this example, resolution was prioritized while increasing the single FOV using low-cost cameras (IMX492) in a single shot. To achieve this, a pixel size was selected that is half of the resolution, based on the Nyquist sampling rate. This cost-efficient combination (˜$4000) provides a final pixel size of ˜320 nm with a FOV of ˜5 mm² (2.8 mm×1.8 mm).

TABLE 1
COMPARISON OF CAMERAS

| | IMX492, Sony | ORCA-Flash4.0 |
|---|---|---|
| | (ASI294MM-P, | V3, |
| | ZWO) | Hamamatsu |
| Price (USD) | 1,180 | 16,000 |
| Pixel size (μm) | 2.3 × 2.3 | 6.5 × 6.5 |
| Sensor resolution (px) | 8288 × 5644 | 2048 × 2048 |
| Dark current @ −10° C. | 0.007 | 0.006 |
| (electrons/pixel/s) | | |
| Read noise (electrons) | 2.6 | 1.6 |
| Peak Quantum Efficiency (QE) | 87% @ 500 nm | 82% @ 560 nm |
| Max frame rate with USB3.0 (fps) | 5.7 | 40 |

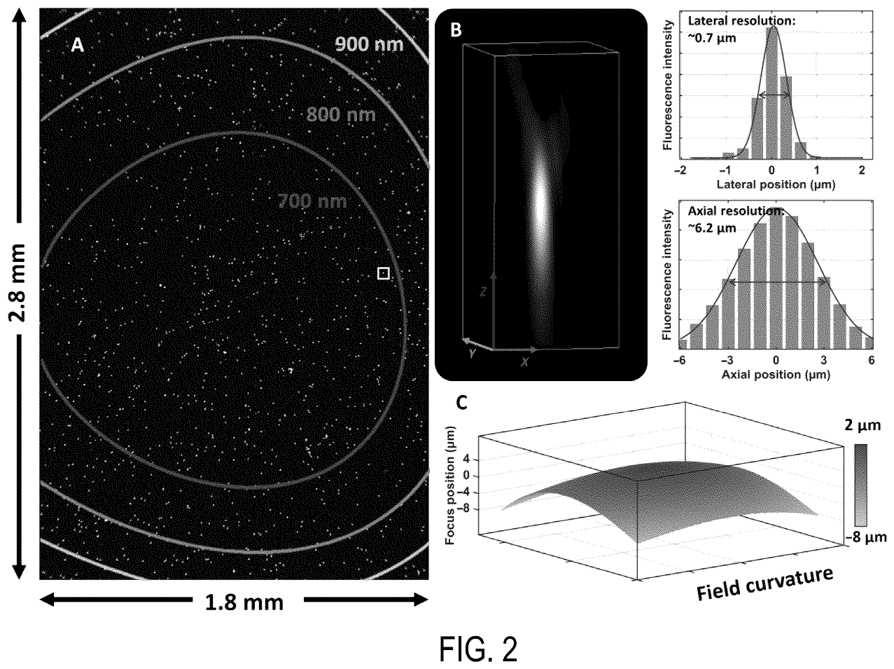

Using the system 100, a series of images of fluorescent microspheres was captured along the axial dimension with a step size of 1 μm. Then, each image was localized from the 3D fluorescent images, and the fluorescence intensity distribution of each microsphere was used to determine the point spread function of the imaging system across the FOV. FIG. 2 illustrates a performance evaluation of the system 100 in resolution and field curvature. Image A of FIG. 2 is a diffraction-limited image of the fluorescent microspheres (FluoSpheres, 0.2 μm, 505/515) attached to the surface of a coverslip. To generate a precise and continuous map in resolution, the resolution at each position was calculated by averaging the resolution of tens of beads within a radius of 50 μm. Image B of FIG. 2 shows the point-spread function (PSF) of the lateral and axial resolution. A Gaussian function is used to fit the PSF of each fluorescent microsphere, and the full width at half maximum (FWHM) of the PSF is defined as the spatial resolution. Graph C shows the field of curvature for the Omni-Mesoscope. The focus shift at each positions was calculated by averaging the axial position of all beads within a lateral radius of 50 μm.

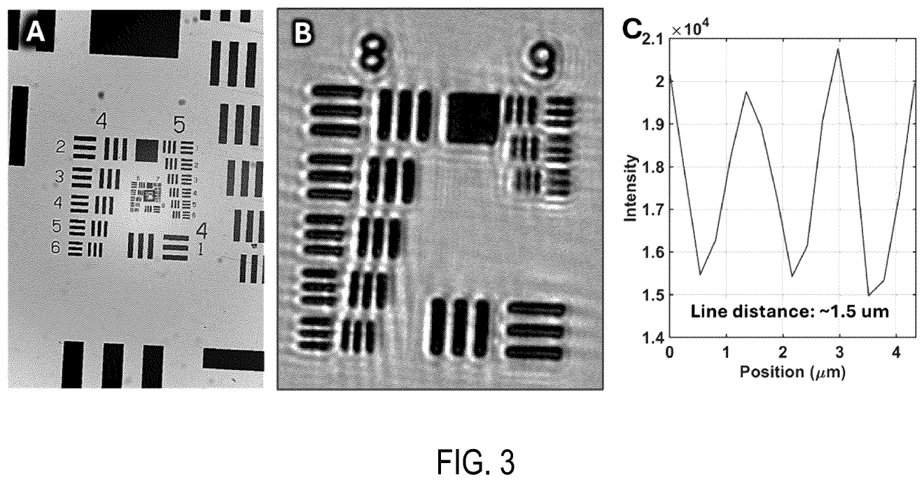

FIG. 3 illustrates another performance evaluation of the system 100 using the USAF 1951 high-resolution target. In image A of FIG. 3, a single field of view in bright-field imaging mode is shown. Image B of FIG. 3 is of the zoomed-in region showing group 9 to demonstrate the high resolution of the system 100. From graph C of FIG. 3, which illustrates the intensity provide of group 9 element 3, it can be seen that the system 100 can resolve line groups with a spacing of 1.5 μm.

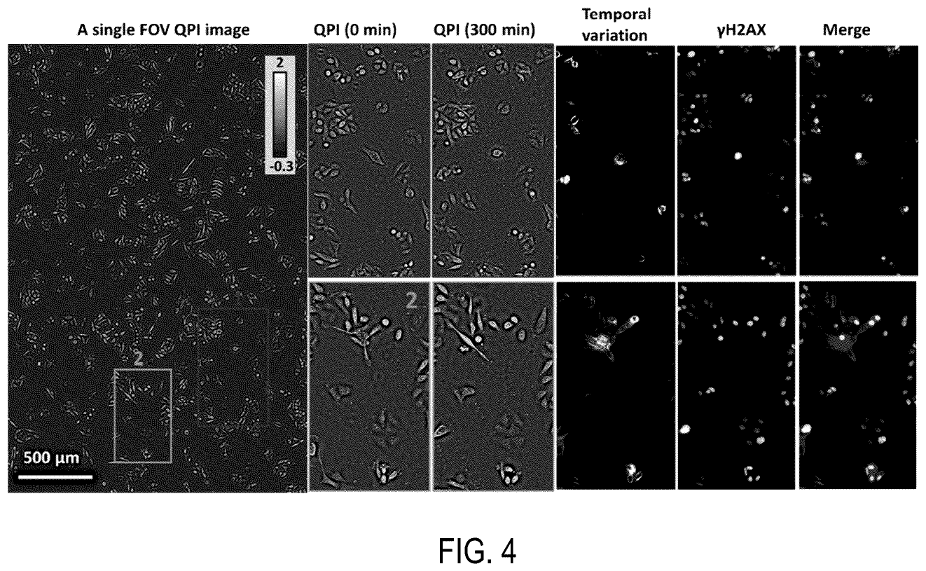

As shown in FIG. 2, the Omni-Mesoscope achieves a lateral sub-micrometer resolution (700 to 900 nm) and an axial resolution of ˜6.2 to 8.7 μm across the entire FOV (2.8 mm×1.8 mm). At the central region of the FOV, the system 100 maintains a lateral resolution of about 700 nm. The system 100 can resolve line groups with a spacing of 1.5 μm, as illustrated in FIG. 3. Graph C of FIG. 2 shows the field curvature of the system. Initially, the focus shift at the edges of the FOV can reach 8 to 10 μm; however, this is reduced to less than 1 μm after applying region-based post-refocusing, which is illustrated in FIG. 4, showing the correlation of dynamic cellular behaviors with DNA damage (γH2AX) in SW480 cells treated with 5-fluorouracil (5-FU).

The images in FIG. 4 include a representative quantitative phase image of SW480 cells treated with 35 μm 5-FU for 3 days, captured within a single field of view containing thousand cells. Representative sequential snapshot images from Box 1 (top row) and Box 2 (bottom row) illustrate the dynamic morphological changes over 5 hours. The temporal standard deviation of the QPI videos was utilized toe valuate the local cell dynamics and movement. Most cells exhibit minimal movement, as indicated by a lower temporal phase variation, while a subset demonstrates significant local motion, depicted by high temporal phase variation. The cells display larger motions correspond to a higher DNA damage level, as evidenced by the higher intensity in the γH2AX image.

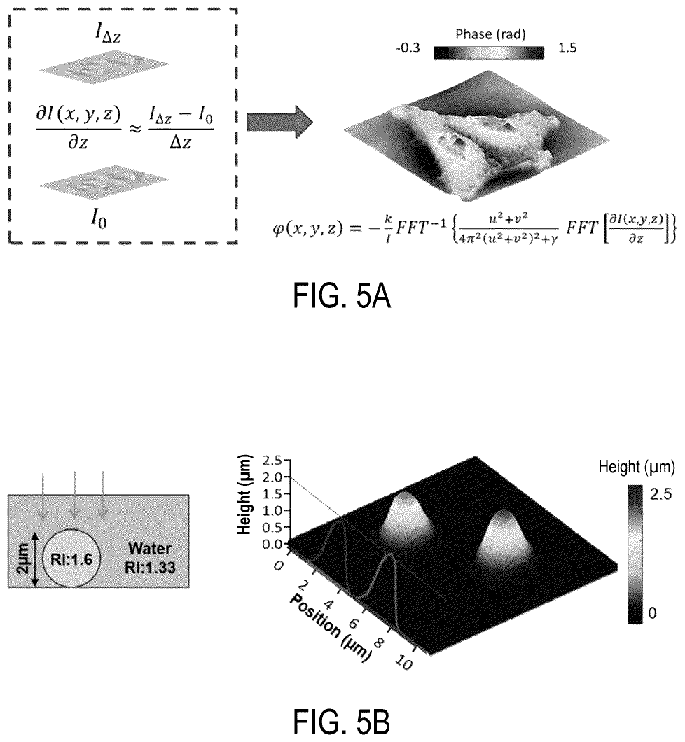

The quantitative phase images are reconstructed on the basis of the TIE-based phase retrieval using bright-field intensity measurement at two different focal planes (±2 μm), which provides simplicity and speed. In addition, the methods set forth herein do not require modification of the optical setup for fluorescence imaging compared to the interferometry-based quantitative phase imaging method. The accuracy of the quantitative phase value and temporal stability were validated using the polystyrene microsphere with a diameter of 2 μm, as shown in FIGS. 5A and 5B. FIG. 5A shows the basis of TIE-based QPI, which is based on calculating the image gradient along the axial dimension. FIG. 5B shows the validation of the performance of TIE-based QPI using the polystyrene microspheres with a 2-μm diameter.

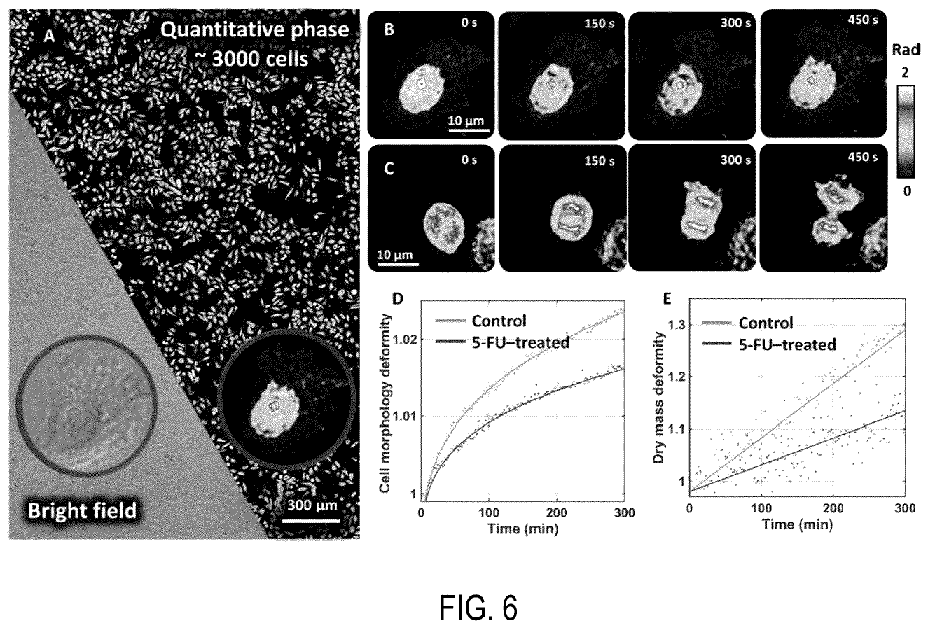

As noted above, the system 100 may be used for label-free live-cell imaging with TIE-based QPI (that is, as a QPI-Mesoscope). To demonstrate this, the quantitative phase imaging module of the Omni-Mesoscope was first applied for label-free live-cell imaging, where an incubator system was set up with the temperature set to 37° C., humid air, and 5% CO₂. FIG. 6 illustrates this modality. Image A presents quantitative phase images of cancer cells in a single FOV, with ˜3000 cells. The inset shows the comparison between the quantitative phase images and comparative bright-field images. As shown in image A of FIG. 6, the quantitative phase images of cancer cells (SW480) exhibit significantly higher contrast compared to the comparative bright-field images, thus enabling the identification of subcellular structures. Leveraging the mesoscale FOV, the QPI-Mesoscope can simultaneously monitor ˜3000 cells with the ability to capture the heterogeneous cellular dynamics and rare events in a large cell population without the need for scanning or stitching various regions of interest. Moreover, for long-term monitoring, the snapshot imaging feature may be used, as it substantially reduces light exposure, thereby minimizing the effects of phototoxicity. As shown in image set B of FIG. 6, the system 100 can track dynamic changes in the cytoskeleton with great subcellular details to visualize large skeletal structural features. Rapid events of mitosis that lasted for about 5 min over a 5-hour observation period, were also observed as shown in image set C of FIG. 6.

This quantitative phase image provides enhanced image contrast and is also quantitative in nature. Graphs D and E of FIG. 6 show the quantification of cell morphological similarity and changes in dry mass in cancer cells without (“control”) and with the treatment of 5-FU (“5-FU-treated”) over 5 hours. Cell morphology deformity is quantified as the inverse of the image similarity between QPI images captured over 5 hours and those captured at the initial time point. The total dry mass of a cell is estimated by dividing the product of the quantifiable phase and cell area by the specific refractive index increment. Normalized dry mass is calculated by dividing the dry mass of the total cells captured at each time point by that captured at the initial time point. The results reveal that, as cells grow, their morphology gradually becomes less similar over time. In response to 5-FU treatment, the cell morphology undergoes less significant deformation. Similarly, the dry mass gradually increases during cell growth. The treatment with 5-FU also slows down the increase in dry mass, suggesting that the chemotherapy drug reduces protein synthesis during cell growth.

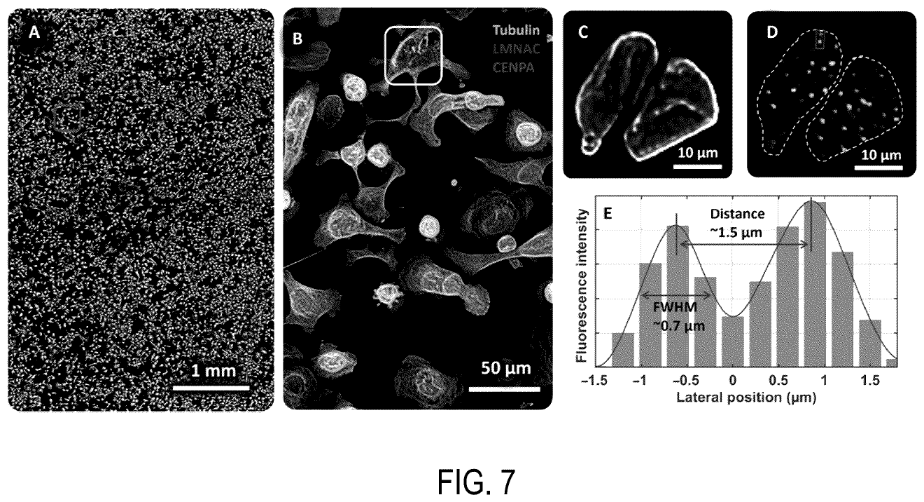

The system 100 may also be used for high-resolution multiplex fluorescence imaging of biological samples (that is, as a Fluo-Mesoscope). To demonstrate this, the imaging performance of the Omni-Mesoscope was evaluated for highly multiplex fluorescence imaging on biological samples using cancer cells (SW480). Three subcellular structural components (tubulins, lamin A/C, and centromeres) were used in this evaluation, and are illustrated in FIG. 7. Images A and B of FIG. 7 are fluorescence images of tubulin, lamin A/C, and centromeres over a large area (2×2 images stitched together) in which image B represents the zoom region of the box from image A. Images C and D of FIG. 7 show the zoom region of the box from image B for lamin A/C (LMNAC) and centromere, respectively.

The results further illustrate the capability of Fluo-Mesoscope to obtain high- resolution fluorescence images over an ultra-large FOV at high throughput while still resolving fine biological structures, such as the two closely adjacent centromeres. As shown in graph E, the FWHM of a single centromere was measured at 0.7 μm, and the distance between the two adjacent centromeres was at 1.5 μm, confirming the high-resolution imaging capability of Fluo-Mesoscope. These results also agree with the resolution defined using fluorescence microspheres (see FIG. 2), further validating the accuracy and consistency of the mesoscopic imaging system 100.

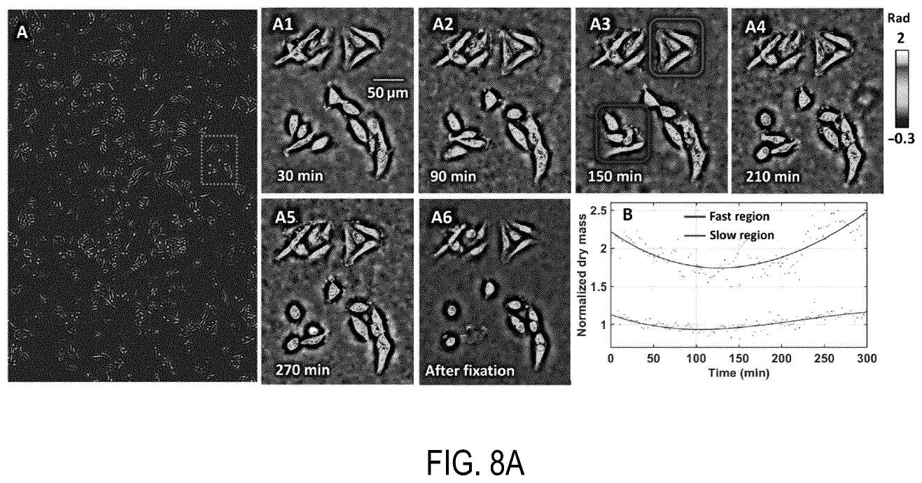

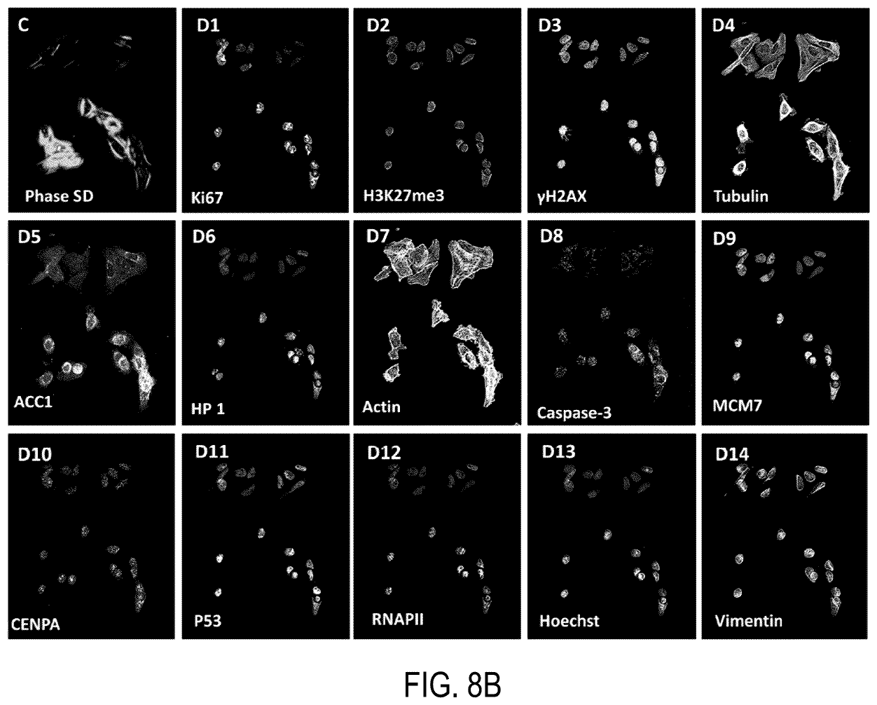

One advantage of an ultra-large FOV in the Omni-Mesoscope is its ability to detect rare dynamic cellular events, which can be linked to their underlying function through high-content molecular profiling in situ. This capability was demonstrated through the observation of the response of a cancer cell line, SW480, to the treatment of 5-FU. Using the capability of the Omni-Mesoscope for quantitative phase imaging, dynamic morphological changes across a large cell population of a few thousand cells were simultaneously monitored for 5 hours within a single FOV. Within the predominantly slow-moving cell population, a distinct subset was identified that exhibited rapid and significant local movements. These observations are exemplified by FIGS. 8A and 8B, which show the correlation of dynamic cellular behaviors with molecular characteristics in SW480 cells treated with 5-FU.

In FIG. 8A, image A shows a single-FOV quantitative phase image of SW480 cells treated with 35 μM 5-FU for 3 days. Images A1 to A5 are representative sequential snapshot images from the box in image A, which illustrate the dynamic morphological changes over 5 hours in SW480 cancer cells treated with 5-FU for 3 days, captured within a single FOV encompassing thousands of cells. Most cells display minimal movement, while a subset exhibits significant local motion. Image A6 is a quantitative phase image after fixation with paraformaldehyde (PFA), serving as a baseline for molecular analysis by preserving cellular structures for detailed examination. Graph B of FIG. 8A shows the normalized dry mass of four cells in the fast-moving region and slow-moving region in image A3. It can be seen that the quantitative dry mass from the nuclei of these fast-moving cells is almost doubled compared to that of slow-moving cells. In FIG. 8B, image C is a temporal SD map of phase images highlighting cells with pronounced movement, indicating areas of active cellular dynamics in response to treatment. Images D1 to D14 are fluorescence images of 14 molecular markers in the identified fast-moving cells and adjacent slow-moving cells. These markers include DNA damage (γH2AX), apoptosis (cleaved caspase-3), proliferation (Ki67 and MCM7), cytoskeletal integrity (actin and tubulin), fatty acid metabolism (Acetyl-CoA-carboxylase 1 (ACC1)), tumor suppressor (p53), DNA content (H3), heterochromatin (HP1), euchromatin (H3K9ac), centromeres (CENPA), active transcription (phosphorated RNAPII), and mesenchymal marker (vimentin), providing a comprehensive molecular profile associated with the observed dynamic behaviors

To uncover the function and molecular characteristics of these cells with distinct fast dynamics, the cells with PFA after 5 hours of live-cell imaging. As shown in the quantitative phase image A6 of FIG. 8A, some morphological changes are expected after fixation, such as cell shrinkage and flattening cytoplasm. However, the cellular morphology and the relative phase difference for different cells and subcellular compartments were largely preserved. Subsequent cyclic immunofluorescence staining and imaging on the Omni-Mesoscope revealed distinct molecular signatures from 14 different molecular markers for the same cells, presented as images D1 to D14 of FIG. 8B. Notably, the fast-moving cells displayed significantly elevated levels of DNA damage marked by γH2AX, spread over the entire nucleus. This type of pan-nuclear pattern of γH2AX without foci indicates excess DNA damage from acute apoptosis, distinct from the typical distinguishable γH2AX foci of DNA damage marker. Further, these cells showed increased levels of apoptosis (cleaved caspase-3) and proliferation (evidenced by Ki67 and minichromosome maintenance 7 (MCM7), alongside increased expression of cytoskeletal proteins (actin and tubulin), enhanced metabolic activity (ACC1, a marker for lipid or fatty acid metabolism), and higher DNA content (indicated in H3, HP1, H3K9ac, and centromeres), while similar levels of vimentin indicate that the cells have not transitioned to a mesenchymal phenotype.

These observations collectively suggest that the fast-moving cells are undergoing significant DNA damage with features of pan-nuclear DNA damage, leading them toward lethal apoptosis in DNA replication stress. However, before succumbing to cell death, these cells show considerable chromatin condensation and marked mobility, supported by a marked increase in metabolic enzymes and cell proliferation proteins. The observed increase in DNA content and dry mass in cells suggests ongoing DNA replication and protein synthesis, yet without subsequent cell division. These results, revealed by the Omni-Mesoscope, provide functional insights into the complex cellular dynamics linked to their response mechanisms to chemotherapy drugs including those rare events.

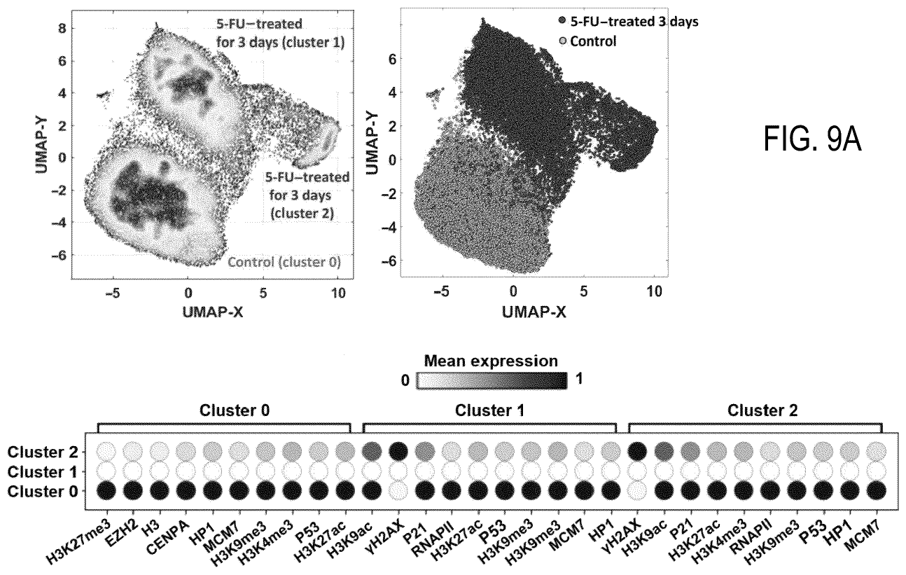

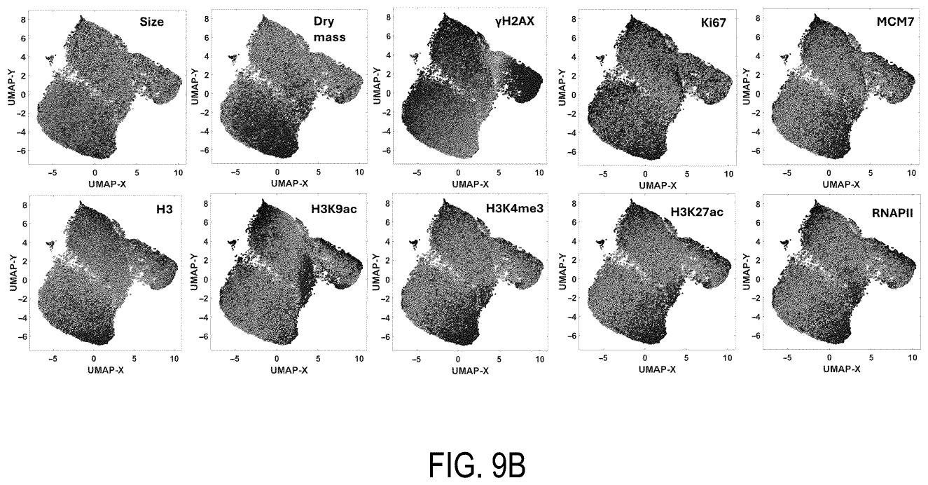

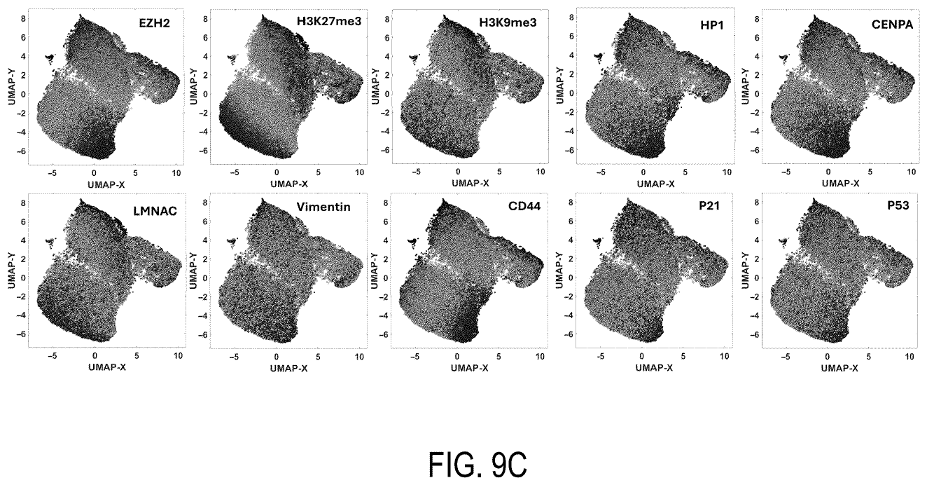

Furthermore, the Omni-Mesoscope not only facilitates the detection of rare events but also allows a comprehensive analysis of the relationship between these events and the molecular characteristics of individual cells within the entire cell population, all obtained in situ. A uniform manifold approximation and projection (UMAP) analysis was performed for a comprehensive set of 20 markers focusing on the key functions of cell proliferation and epigenetic regulation for ˜15,000 cells (SW480), both untreated and treated with 5-FU. This analysis is illustrated in FIGS. 9A-9C. FIG. 9A shows, at top, the UMAP visualization of the clustered three groups of control cells (SW480) and those treated with 5-CU. At bottom, FIG. 9A shows a visualization of mean expression level of those proteins with the most significant changes between each pair of the clusters. FIGS. 9B and 9C show a series of panels, where each panel represents the distribution of the fluorescence intensity for each marker on the clustered UMPA.

The UMAP analysis in FIGS. 9A-9C unveiled a distinct, small cluster (cluster 2) of 5-FU-treated cells located on the right side of the visual representation. The UMAP revealed that there is a distinct cell cluster with exceptionally strong signals of γH2AX, indicative of severe pan-nuclear DNA damage. Notably, even within this cluster, there is significant heterogeneity in other morphological and molecular characteristics, such as nuclear size, cell dry mass, DNA content, proliferation status, transcription activities, and epigenetic states, suggesting diverse cellular outcomes in response to 5-FU treatment. Further analysis also revealed a strong correlation between the temporal SD map of phase images from the fast-moving cells and those displaying intense γH2AX signals, as shown in FIG. 4 and described above. Those fast-moving cells represent a minor fraction (<10%) of the cell population, even among those with excessive DNA damage, emphasizing the rarity of these events.

In addition to significant DNA damage, further analysis of the 20 markers reveals that most nuclear proteins are down-regulated in 5-FU-treated cancer cells. This includes H3K27me3 (heterochromatin), EZH2 (the enzyme catalyzing H3K27me3 formation), total H3 (core histone), CENPA (centromeres), HP1 (heterochromatin protein 1), RNA polymerase II (RNAPII; active transcription), along with reduced cell proliferation markers (MCM7 and Ki67). These findings suggest a global reduction in chromatin and transcription activity, which may be due to slower cell growth and protein synthesis.

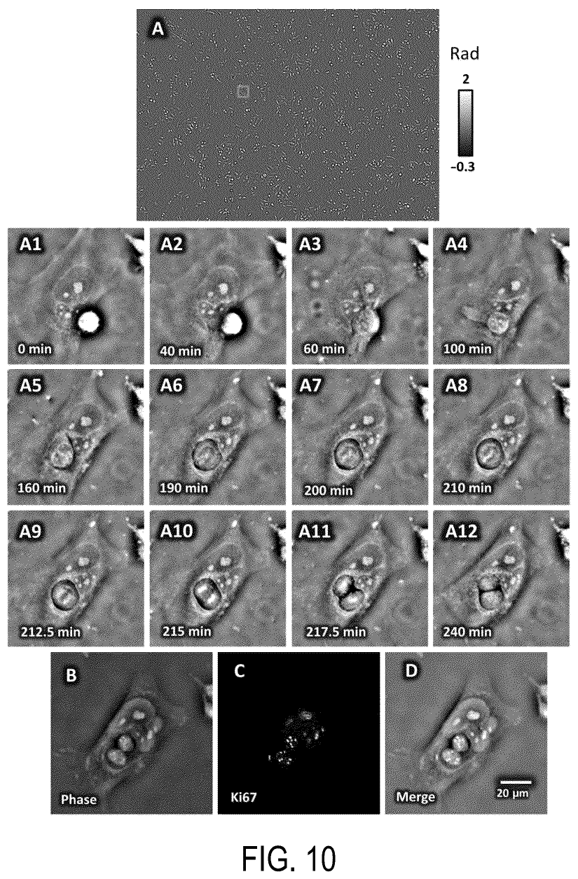

The Omni-Mesoscope may also be used in characterizing drug-resistant cancer cells. To demonstrate this, live-cell imaging was conducted for drug-resistant cancer cells that adaptively developed resistance throughout the treatment with increasing concentrations of 5-FU over ˜3 months. During a 5-hour imaging session, the cellular dynamics in these drug-resistant SW480 cells in the presence of 6 μM 5-FU were monitored and compared to the dynamics of the corresponding parent SW480 cancer cells. As the cancer cells adapt and develop chemoresistance, the large FOV provided by Omni-Mesoscope allowed observation of the highly heterogeneous dynamic behaviors of these cells. In particular, the formation of polyploid cells through the mechanism of cell engulfing and cell fusion was observed. FIG. 10 shows this formation. Image A of FIG. 10 is a single-FOV quantitative phase image of drug-resistant cancer cells SW480 in the presence of the 6 μM 5-FU. Images A1 to A12 are representative sequential images from the box in image A, and reveal the formation of polyploidy in drug-resistant cancer cells. As shown in images A1 to A12 of FIG. 10, a cell was first engulfed into an existing polyploid cell, becoming flattened, as corroborated by a lower phase value indicative of a thinner cell inside the polyploid cells. This engulfed cell was then divided into two daughter cells within the large polyploid cell. Three such cell-engulfing events were observed over the entire FOV of ˜5 mm² with ˜1500 cells over 5 hours. In addition, an event involving cell fusion with the polyploid cell was observed.

The sub-micrometer resolution of the Omni-Mesoscope enables the detection of functionally significant subcellular dynamics. As illustrated in images B to D of FIG. 10, the quantitative phase image reveals dense puncta within the cell nuclei, which correlate strongly with the corresponding Ki67 fluorescence intensity. Image B of FIG. 10 is a quantitative phase image after fixation, serving as a baseline for molecular analysis by preserving cellular structures for detailed examination. Image C is a fluorescence image of Ki67 markers. Image D is a merged quantitative phase and fluorescence image, and shows a high level of correlation between the phase value and the fluorescence intensity of Ki67. This observation indicates that the label-free quantitative phase images can reveal dynamic morphological changes with subcellular details, specifically within nuclear protein Ki67. Smaller dense puncta of Ki67 are evident in the daughter cells derived from the engulfed cell, while larger dense Ki67 puncta are observed in the nuclei of the existing polyploid cells, reflecting their different stages of the cell cycles.

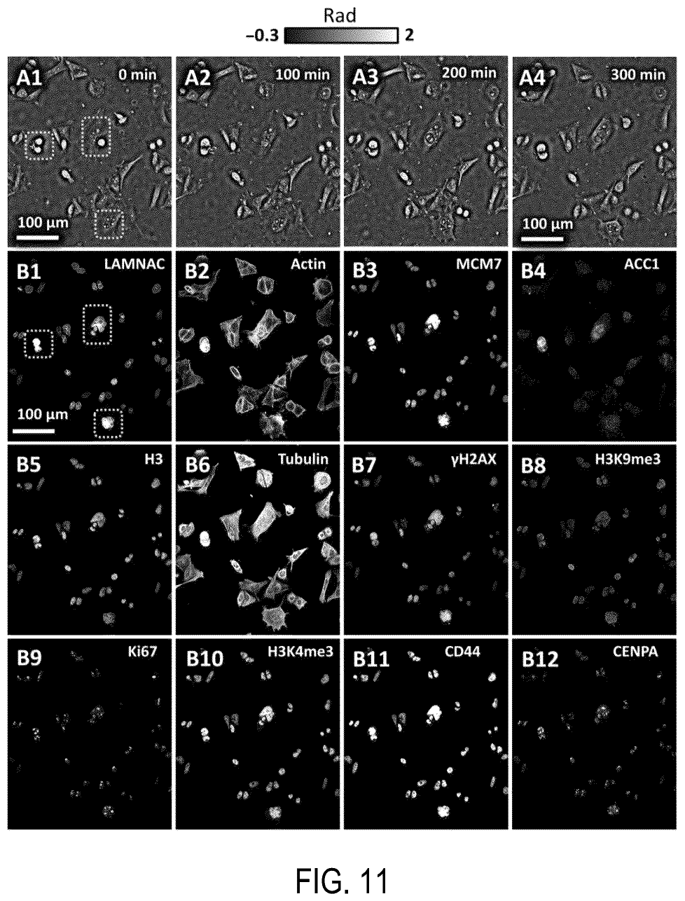

Building on these observations, FIG. 11 details the underlying high-content molecular profiling that outlines the specific molecular characteristics of these polyploid cells. In FIG. 11, images A1 to A4 are representative sequential images cropped from the FOV illustrate the dynamic morphological formation of polyploidy over 5 hours in SW480 drug-resistant cells. The dashed box highlights the polyploid cells. Images B1 to B12 are fluorescence images of 12 molecular markers in the polyploidy cells and other drug-resistant SW480 cells. These markers include DNA damage (γH2AX), proliferation (Ki67 and MCM7), cytoskeletal integrity (actin and tubulin), fatty acid metabolism (ACC1), DNA content (H3), heterochromatin (H3K9me3 and H3K4me3), centromeres (CENPA), lamin A/C (LMNAC), and cancer stemness (CD44), providing a comprehensive molecular profile associated with the observed polyploidy.

These polyploid cells exhibit strong stemness (high level of CD44), active fatty acid metabolism (ACC1), significant proliferation (MCM7), and high level of DNA damage (γH2AX). These molecular traits are consistent with a mechanism whereby polyploidization enables cancer cells to survive harmful conditions. Cell cannibalism and cell fusion are also possible mechanisms for polyploidy formation, which the direct observations using dynamic cellular imaging in a single FOV confirmed. Further, the quantitative phase images captured highly dynamic cytoskeleton activities, such as cytoskeleton extrusion, which is particularly pronounced in these polyploid cells. The underlying molecular profiling confirms that the extrusion structure comes from both actin and tubulin, suggesting their role in facilitating fast cell movement.

This approach underscores the value of combining label-free dynamic cellular imaging with deep molecular analysis to uncover critical cellular responses to treatment. By facilitating the identification of specific cell subsets undergoing significant stress or damage, such as those highlighted in the UMAP analysis, the methodology set forth herein, coupling morphodynamic imaging over a large cell population with subsequent high-content molecular profiling, offers a powerful tool for understanding the heterogeneity of cellular responses to pharmacological interventions.

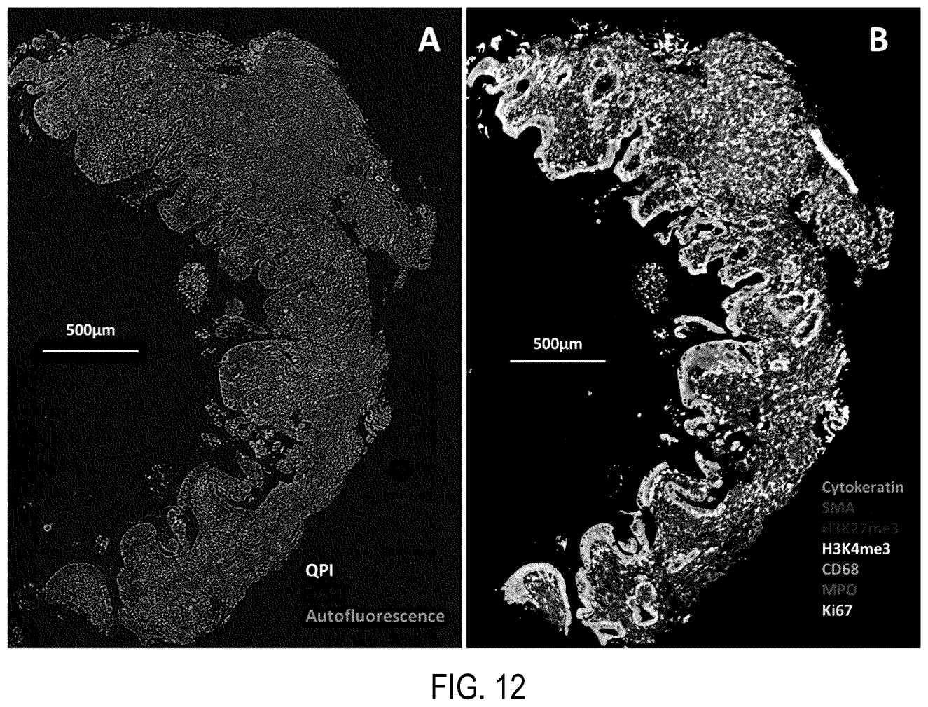

As a versatile imaging platform, the Omni-Mesoscope can also enhance the throughput for highly multiplexed tissue imaging. FIG. 12 shows multiplex fluorescence images of a human tissue section with ulcerative colitis, captured using the Omni-Mesoscope. Image A of FIG. 12 is a composite image that incorporates a quantitative phase image, a DAPI fluorescence image, and an autofluorescence image excited by a 470 nm laser. Image B of FIG. 12 is a multiplex image showing cell type and functional markers including Cytokeratin, SMA, H2K27me3, CD68, MPO, and Ki67. The image is generated by stitching two single FOV images with an overlapping ratio of 10%. As shown in FIG. 12, with significantly improved FOV and imaging speed, the whole-slide imaging of a tissue section from a small tissue biopsy only requires two images in just a few seconds.

As noted above with regard to FIG. 2, this ultra-large FOV wide-field optical microscopy methodology has an axial resolution of ˜6 μm. In 3D sectioning implementations, the long depth of field increases the background from thick tissue, which may affect image quality. Thus, for 3D volumetric imaging implementations, The Omni-Mesoscope may be supplemented with expansion microscopy. Expansion microscopy physically enlarges biological specimens, enabling imaging at resolutions surpassing those attainable with comparative microscopy methods. The expansion process not only enhances resolution but also significantly mitigates scattering and increases sample transparency.

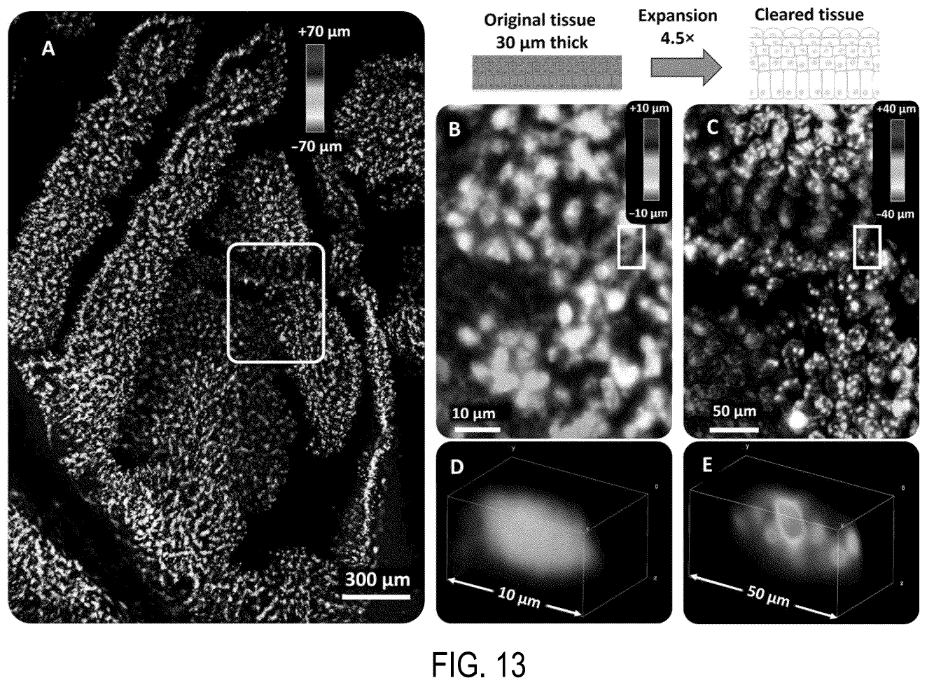

FIG. 13 shows an example of 3D volumetric super-resolution imaging of thick tissue using the Omni-Mesoscope with expansion microscopy. Image A of FIG. 13 is a 3D volumetric super-resolution image of nuclei (4′,6-diamidino-2-phenylindole) on an expanded sample (˜4.5× expansion, 1× phosphate-buffered saline) from a 30-μm-thick section of mouse small intestine tissue, obtained using the Omni-Mesoscope. Images B and D are images of the tissue section before expansion, showing the degraded resolution and high background. Images C and E are images of the tissue section after expansion, demonstrating improvements in image resolution and 3D sectioning capability of the Omni-Mesoscope by using expansion microscopy.

As shown in image A of FIG. 13, the 3D volumetric super-resolution images of the expanded samples can be obtained with Omni-Mesoscope (estimated to be ˜150-nm lateral resolution and 1.5-μm axial resolution on the basis of 4.5 expansion ratio), on a 30-μm-thick section of mouse small intestine tissue. A comparative analysis of tissues, both before expansion (images B and D) and after expansion (images C and E), reveals a significant enhancement in image resolution after expansion. This enhancement allows for the clear visualization of the 3D epithelial cell nuclei in the villi region of the small intestine, along with the precise 3D locations of individual cells. Notably, the subcellular structure of condensed chromatin foci within each nucleus is also clearly visible. Thus, the Omni-Mesoscope provides an increase in imaging throughput for expansion microscopy. Expanded samples come with a marked volume increase, up to three orders of magnitude after expansion. Consequently, the combination of the Omni-Mesoscope and expansion microscopy provides for ultrahigh-throughput 3D volumetric super-resolution imaging of thick tissue samples, to explore complex biological structures with clarity and detail at high speed.

The system 100 may be built using cost-efficient off-the-shelf components. In one physical example, the system 100 adopts six cost-efficient industry-grade lasers from Civil Laser to provide a large FOV illumination: 405 nm (LSR405CPD-1.2W), 470 nm (LSR470SD-2.5W), 530 nm (LSR530SD-1.2W), 589 nm (LSR589H-1W), 650 nm (LSR650SD-1W), and 750 nm (DL750-T2-1.5W). These six laser lines were combined with dichroic mirrors (T4201pxr, T4951pxr, T5561pxr, T6101pxr, T6851pxr, Chroma), coupled into a multimode fiber (M97L02, Thorlabs) for beam shaping into a flat illumination field. The square-core multimode fiber transforms the original beam with an irregular shape into a uniform beam with a square shape. A high-frequency vibration motor (VZ6DL2B0055211, Digikey) was used to reduce the laser speckle and achieve a high uniformity of up to 99%. The laser intensity was electronically controlled by an Arduino board (Arduino Nano Every) with transistor-transistor logic (TTL) mode.

To increase the signal-to-noise ratio, the illumination path and detection path may be decoupled, and the light obliquely introduced from the bottom of the sample with an incident angle of 60°, which is larger than the collection angle of the objective lens) (45°. This configuration minimizes scattered and reflected light entering the detector, thus significantly reducing the background noise. A custom motorized filter wheel with nine band-pass emission filters (no. 67-040-438CWL, no. 87-762-510CWL, no. 87-765-549CWL, no. 84-116-572CWL, no. 87-767-615CWL, no. 33-328-631CWL, no. 86-996-676CWL, no. 67-052-692CWL, and no. 84-123-832CWL) was used to switch between different fluorescence imaging channels.

For improved live-cell imaging, a tabletop incubator with two levels of environmental control was used to ensure a stable environment. A precise inner chamber incubator (TCS-200, Amscope) was used to maintain the cell chamber at 37° C., and the humid air with 5% CO₂ was injected directly into the chamber incubator. The outer incubator included a temperature controller (ITC-308, Inkbird) and a high-power heater (WY-H1-B1, YOUCIDI) to maintain the temperature of the whole tabletop space consistently at 37° C. with minimal fluctuation (<0.2° C.).

The produced example of the Omni-Mesoscope included two distinct imaging modes: QPI-Mesoscope mode for label-free live-cell imaging, and Fluo-Mesoscope mode for multiplex fluorescence imaging. For live-cell imaging mode, the incubation system is first turned on for appropriate temperature (37° C.) and CO₂ concentration (5%). The incubation system achieved a stable condition in about 10 min. The imaging chamber is then mounted and the automatic live-cell imaging is started. During the imaging process, the Omni-Mesoscope automatically finds the focus by scanning the sample along the axial direction and identifying the focal plane where the captured bright-field images exhibit the lowest normalized variance of the pixels. The bright-field images captured at different axial positions at ±2-μm step size are also used for TIE-based quantitative phase reconstruction and refocusing. Live cells were monitored for more than 5 hours with a time interval of 150 s. For multiplex fluorescence imaging mode, a similar bright-field image-based strategy was used for autofocusing. Furthermore, a 3D stack of fluorescence images was also captured for subsequent region-based refocusing. The exposure time was adjusted to achieve a high contrast for each fluorescence channel.

Image processing steps, as illustrated in FIGS. 14A-14C, may be used to further improve image quality. One such processing technique, illustrated in FIG. 14A, is flat-field calibration. In the physical example, two strategies were used to achieve uniform fluorescence imaging. First, a multimode fiber with a square core was used to create uniform illumination, with a vibration motor used to reduce speckle effects. This approach enables illumination uniformity of more than 96%. However, the detection efficiency of the objective lens was not uniformly distributed. Second, under uniform illumination, multiple fluorescence images at different positions of the same sample were captured. The average fluorescence intensity at each position was calculated to generate a 2D relative intensity map. Subsequently, a 2D cubic polynomial function was fitted to this map to obtain a 2D normalization map for each pixel. This map calibrated the detection efficiency and produced the final optimized flat-field image with uniformity exceeding 96%.

Another technique to achieve uniform fluorescence imaging, illustrated in FIG. 14B, is region-wise refocusing. Given that all objective lenses exhibit field curvature, region-wise refocusing may be implemented to address defocusing issues at the edge of the field of view. Fluorescence microspheres placed on a no. 1.5 coverslip were used to capture 3D image stacks, from which the 3D position of each emitter was retrieved. A 2D cubic polynomial function was then fitted to generate a field curvature map. The full image was divided into 9×6 regions, and refocusing was performed by identifying the focal plane within each region. In-focus regions replaced defocused ones to minimize defocus distortions, resulting in a reduction of defocusing distance to ±1 μm.

Uniform fluorescence imaging may also be achieved by background reduction, denoising, and deconvolution as illustrated in FIG. 14C. In the example, the rolling ball algorithm (implemented with the MATLAB function “imboxfilt’) with a 20-pixel diameter was used to reduce background, leading to an average signal-to-background ratio improvement of two- to fivefold (34, 35). In addition, a Wiener filtering algorithm (implemented with the MATLAB function “wiener2’) was applied to reduce noise and enhance spatial resolution, resulting in a 10 to 20% improvement.

The physical example used a customized imaging chamber that uses magnetic forces at multiple positions to adjust the translational and rotational positioning for each imaging cycle. Combined with a closed-loop translation stage (Thorlabs), the Omni-Mesoscope can locate targets with a precision of 200 μm, which is significantly smaller than the imaging FOV. A scanning process was then conducted over a 5×3 FOV grid with a 20% overlap, resulting in a scan region of more than 30 mm². This approach allows the capture of more than 90% of the cells across multiple imaging cycles within the large scanning region. Last, a cross-correlation algorithm was used to stitch the images. The phase images from each cycle were then used to register the fluorescence images from each cycle using the scale-invariant feature transform.

In brief, quantitative phase images from different cycles are registered using the scale-invariant feature transform (SIFT) method, with the image from the first cycle as the reference. SIFT key points are detected independently in each image, and feature vectors describing local image gradients around these key points are extracted. Matched features between images are identified by calculating pairwise Euclidean distances between the feature vectors. A 2D similarity geometric transformation matrix is then computed to align the images. All steps, including key point detection, feature extraction, matching, and transformation, were implemented using MATLAB's Image Processing and Computer Vision Toolbox.

The UMAP package written in MATLAB is used for data analysis with default parameter setting (min_dist=0.3, n_neighbors=15, metric=Euclidean, randomize=1). The data were analyzed using the Scanpy pipeline. First, principal components analysis (PCA) was applied to reduce the dimensionality and calculated the nearest neighbors in the PCA space. UMAP was then used for data visualization and the Leiden algorithm with a resolution of 0.075 was used for clustering. Last, a t test was performed to identify differentially expressed markers within each cluster.

For the QPI-Mesoscope implementation, the TIE is essentially an expression of the conservation of energy in optics. It establishes a direct mathematical relationship between the spatial phase and the derivative of intensity along the optical axis, enabling the retrieval of quantitative phase values by measuring the phase-induced intensity gradient according to the following Expression 1.

$$- k \frac{\partial I ( x , y , z )}{\partial z} = {∇}_{⊥} \cdot [ I ( x , y , z ) {∇}_{⊥} φ ( x , y , z ) ] \qquad ( 1 )$$

In Expression 1, φ is the phase, k is the wavenumber (corresponding to 2π/λ), λ is the wavelength, I is the image intensity, ∂I/∂z represents the intensity derivative, ∇₁₉₅ is the lateral gradient operator, x and y indicate the lateral spherical coordinate, and z indicates the axial axis. For a phase object under uniform illumination, the intensity along the optical axis is nearly constant, and the TIE can be further simplified as a Poisson equation according to the following Expression 2.

$$- \frac{k}{I} \frac{\partial I ( x , y , z )}{\partial z} = {∇}_{⊥}^{2} φ ( x , y , z ) \qquad ( 2 )$$

Then, the spatial phase distribution can be expressed as the following Expression 3.

$$φ ( x , y , z ) = - \frac{k}{I} {∇}_{⊥}^{- 2} \frac{\partial I ( x , y , z )}{\partial z} \qquad ( 3 )$$

The inverse Laplacian operator (∇⁻²) can be efficiently calculated using the fast Fourier transform (F). Therefore, the phase distribution can be reconstructed according to the following Expression 4.

$$φ ( x , y , z ) = - \frac{k}{I} {ℱ}^{- 1} \{ \frac{{u}^{2} + {v}^{2}}{4 {{π}^{2} ( {u}^{2} + {v}^{2} )}^{2} + γ} ℱ [ \frac{\partial I ( x , y , z )}{\partial z} ] \} \qquad ( 4 )$$

In Expression 4, u and v are the spatial frequencies corresponding to the lateral axis, and γ is a regularization parameter to avoid the singularity and remove noise-induced artifacts. Because the axial intensity derivative cannot be measured directly, finite differences are used to approximate the derivative in practice. In its simplest form, TIE phase retrieval requires only two bright-field intensity images collected at different focuses along the axis dimension according to the following Expression 5, where Δz is a small defocus axial distance to provide a good estimate of the intensity derivative.

$$\frac{\partial I ( x , y , z )}{\partial z} = \frac{I ( x , y , Δ z ) - I ( x , y , 0 )}{Δ z} \qquad ( 5 )$$

Above, where measurements of dry mass are provided, the total dry mass of a cell was estimated by dividing the product of the phase value and cell area by the specific refractive index increment. Normalized dry mass is calculated by dividing the dry mass of the total cells captured at each time point by that captured at the initial time point.

The SW480 cells growing on the gelatin-coated coverslip were exposed to 35 μM 5-FU for durations of 3 days. Subsequently, the cells were imaged using QPI-Mesoscope under live-cell imaging conditions (37° C., 5% CO₂) for 5 hours. Immediately after QPI, the cells were fixed with 4% PFA for 15 min, followed by cyclic fluorescence staining.

To develop drug-resistant SW480 cells, the SW480 cells were gradually exposed to increasing concentrations of 5-FU, starting with 1 μM, followed by 2 μM, and then 4 μM, before reaching a final concentration of 6 μM. The cells were maintained at each concentration for about 4 weeks. Throughout this period, the culture medium at each concentration was refreshed every 3 days to maintain optimal conditions. Subsequently, the cells were imaged live using QPI- MesoScope under 37° C. and 5% CO₂ for 5 hours. Immediately after imaging, the cells were fixed with 4% PFA for 15 min, followed by cyclic fluorescence staining.

For cyclic fluorescence staining, cultured cells were briefly washed with 1× phosphate-buffered saline (PBS) before being fixed with 4% PFA for 15 min at room temperature (RT). Fixed cells were rinsed with 1× PBS twice before permeabilization with 0.2% Triton X-100 in 1× PBS for 10 min. The cells were incubated with a blocking buffer containing 5% bovine serum albumin in 1× PBS for 30 min at RT. All antibodies were diluted in a blocking buffer. The dilutions and usages of antibodies in each cycle were documented, as set forth in Table 2. The cells from the initial staining or previous bleached cycle were stained with diluted primary or fluorophore-conjugated antibodies at 4° C. for 12 hours in a moisture chamber. The cells were then washed with 1× PBS three times. For indirect immunofluorescence staining, after incubation with primary antibodies, diluted secondary antibodies in blocking buffer were added to the cells for incubation at RT for 2 hours, followed by three washes with 1× PBS. The stained cells were stored in 1× PBS until imaging.

TABLE 2
ANTIBODIES USED FOR MULTIPLEX FLUORESCENCE IMAGING

| | | | | | Conjugated |
|---|---|---|---|---|---|
| Antibody | Vendor | Catalog # | Dilution | Cycles | Dye |
| LMNAC | Cell Signaling Technology | 34698SF | 1:400 | 1 | None |
| H3K27me2 | Cell Signaling Technology | 9733S | 1:200 | 1 | None |
| Goat Anti-Rabbit IgG (H + L) | Jackson ImmunoResearch | 111-005-144 | 1:200 | 1 | CF568 |
| Goat Anti-Mouse IgG (H + L) | Jackson ImmunoResearch | 115-005-166 | 1:100 | 1 | AF647 |
| H3 | Santa Cruz Biotech | sc-517576 | 1:100 | 2 | AF405 |
| Ki67 | Cell Signaling Technology | 9449S | 1:400 | 2 | Dy488 |
| Tubulin | Cell Signaling Technology | 5059S | 1:400 | 2 | AF555 |
| MCM7 | Santa Cruz Biotech | sc-9966 | 1:50 | 2 | AF594 |
| CENP-A | Thermo Fisher Scientific | MA1-20832 | 1:50 | 2 | CF647 |
| P53 | Cell Signaling Technology | 5429S | 1:100 | 3 | AF488 |
| Vimentin | BioLegend | 677804 | 1:200 | 3 | AF555 |
| H2Ax | Millipore Sigma | 05-636 | 1:100 | 3 | AF594 |
| H3K9me3 | Abcam | ab89898 | 1:400 | 3 | AF647 |
| HP1 | Santa Cruz Biotech | sc-515341 | 1:100 | 4 | AF405 |
| EZH2 | Abcam | ab283294 | 1:100 | 4 | Dy488 |
| P21 | Cell Signaling Technology | 8493S | 1:100 | 4 | AF555 |
| CD44 | BioLegend | 103054 | 1:100 | 4 | AF594 |
| H3K9ac | Abcam | ab12179 | 1:400 | 4 | AF647 |
| H3K27ac | Abcam | ab177178 | 1:200 | 4 | AF405 |
| Cytokeratin | Invitrogen | 53-9003-82 | 1:200 | 4 | AF488 |
| H3K4me3 | Abcam | ab8580 | 1:200 | 4 | CF568 |
| RNAPII | Abcam | ab5408 | 1:200 | 4 | AF657 |

After each round of fluorescence imaging, the fluorophores were chemically inactivated by incubation in a bleaching buffer containing 4.5% (w/v) H₂O₂ (Sigma-Aldrich, catalog no. H1009) and 20 mM NaOH (solution made from pellets, Sigma-Aldrich, catalog no. S5881) in 1× PBS for 20 min. The samples were continuously illuminated by two high-power full-spectrum light-emitting diodes (YUJILEDS-CRI-95, 380 to 1000 nm, 3.6 W) for fluorescence photobleaching. After 1 hour of photobleaching, the cells were washed with 1× PBS three times to remove residual oxidation solution before being subjected to a subsequent round of immunofluorescence staining.

Reagents used in the above demonstrations of expansion microscopy included PFA (Sigma-Aldrich, P6148), ethanol (Pharmco, 111000200), xylene (Sigma-Aldrich, 214736), sodium acrylate (SA, AK Scientific, R624; Santa Cruz Biotechnology, sc-236893B), N-dimethylacrylamide (DMAA, Sigma-Aldrich, 274135), acrylamide (AA, Sigma-Aldrich, A8887), N,N′-methylenebisacrylamide (BIS, Sigma-Aldrich, M7279), tetramethylethylenediamine (TEMED, Sigma-Aldrich, T9281), 4-hydroxy-2,2,6,6-tetramethylpiperidine 1-oxyl (Sigma-Aldrich, 176141), sodium chloride (NaCl, Sigma-Aldrich, S6191), PBS 10× solution (Fisher Scientific, BP399-1), ammonium persulfate (APS, Sigma-Aldrich, A3678), potassium persulfate (KPS, Sigma-Aldrich, 216224), methacrolein (Sigma-Aldrich, 133035), EDTA (VWR, BDH7830-1), Triton X-100 (Sigma-Aldrich, T8787), Tris Base (Fisher Scientific, BP152-1), proteinase K (Fisher Scientific, EO0491), SDS (Sigma-Aldrich, L3771), urea (Sigma-Aldrich, U5378), and glycine (Sigma-Aldrich, G8898).

To prepare the SA stock solution, a 50% final concentration was achieved by adding deionized water in multiple increments, stirring continuously to ensure complete dissolution. Adequate time was allowed for complete dissolution before final volume adjustment. The monomer solution preparation was composed of Composed of 4% (v/v) DMAA, 34% (v/v) SA, 10% (v/v) AA, 0.02% (v/v) BIS, and 1% (w/v) NaCl in 1× PBS, and was stored at 4° C. until use. The heat denaturation buffer was made of 1% (w/v) SDS, 0.75% (w/v) glycine, 8 M urea, 25 mM EDTA, and 500 mM Tris Base in 2× PBS, adjusted to pH 8.5, and stored at RT.

Formalin-fixed paraffin-embedded pathogen-infected tissue samples underwent deparaffinization through sequential immersion in 2× xylene and 2× 100% ethanol, followed by 95, 70, and 50% ethanol dilutions, and lastly, doubly deionized water. Each step was carried out at RT, lasting 3 min.

For in situ polymer synthesis, before gelation, 0.2 to 0.25% (w/v) APS, 0 to 0.25% (v/v) TEMED, 0.001% (w/v) 4HT, and 0.1 to 0.25% (v/v) methacrolein were added to the monomer solution. After vortexing, the samples were incubated with the gelation solution for 5 to 40 min at 4° C. to allow diffusion without premature gelation. Gelation was completed overnight in a humidified chamber at 37° C., using a setup made from spacers cut from no. 1.5 cover glass and a glass slide. After gelation, mouse colon samples were immersed in a denaturant-rich buffer [1% (w/v) SDS, 8 M urea, 25 mM EDTA, and 2× PBS (pH 7.5)] at RT for 30 min. The homogenization was conducted in a pressure cooker at 120° C. for 80 min. After homogenization, samples were washed twice with 1% decaethylene glycol monododecyl ether (C12E10) in 1× PBS at 60° C. for at least 15 min per wash, followed by two washes at 37° C. to remove SDS. Expanded samples were incubated with 4′,6-diamidino-2-phenylindole (1 μg/ml) for 10 min before imaging.

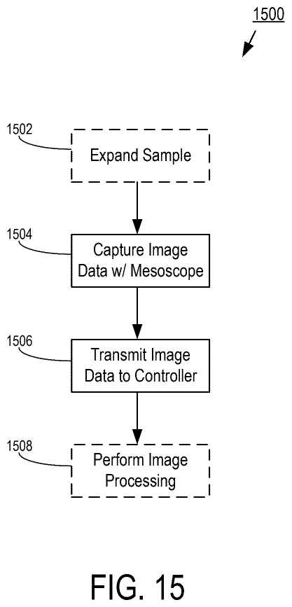

FIG. 15 illustrates an example imaging method 1500. For purposes of explanation, the method 1500 will be described as being performed by the system 100 illustrated in FIGS. 1A and described above. In some examples (i.e., where expansion microscopy is implemented, such as to achieve an Ex-Mesoscope as described above for high-throughput 3D volumetric super-resolution imaging of thick tissue), the method 1500 begins with an operation 1502 of physically expanding the biological sample. In such examples, then, operation 1502 may utilize expansion microscopy techniques.

At operation 1504, image data of the sample is captured using a mesoscope. The mesoscope may correspond to the system 100 of FIG. 1A, and thus include a light source configured to generate an illumination light; an optical system configured to direct the illumination light toward a sample; an objective lens having an NA of approximately 0.5, the objective lens being configured to receive a response light emitted by the sample in response to the illumination light; a filter wheel comprising a plurality of emission filters configured to filter the response light to generate a filtered light; a tube lens configured to provide an optical magnification of approximately 7 to the filtered light; and an image sensor having approximately 50 megapixels and a pixel size of less than or equal to 2.5 μm, the image sensor being configured to receive the filtered light and generate image data based on the received filtered light.

Next, at operation 1506, the image data is transmitted to a controller (e.g., the controller 132 of FIG. 1A). The controller may store the image data in its memory, may transmit the image data to another device (e.g., a cloud server), or both. Additionally or alternatively, the controller may perform one or more image processing operations on the image data. These image processing may include the operations described above with regard to FIGS. 14A-14C; that is, at least one of a flat-field calibration operation, a region-wise refocusing operation, or a background reduction, denoising, and deconvolution operation. The processed images, as with the raw image data, may be stored in the memory of the controller, may be transmitted to another device, or both.

The Omni-Mesoscope provides a multiscale multimodal imaging system that overcomes several limitations of comparative wide-field optical microscopy systems. The Omni-Mesoscope not only provides high-throughput, high-resolution imaging but also uses label-free quantitative phase imaging to observe cell dynamics across a large cell population. Moreover, it connects the noninvasive monitoring of morphological dynamics with information-rich molecular characteristics at an improved scale, resolution, and degree of functional insights. Technically, the Omni-Mesoscope achieves a sub-micrometer lateral resolution for the entire FOV of ˜5 mm² while being usable with off-the-shelf, cost-effective objective lenses and a large-format camera that may be realized at a cost of around $4000, making it highly scalable and affordable. In addition, it is compatible with the standard coverslip-based live-cell imaging chamber without the need for a specialized immersion-based imaging chamber.

The above discussion demonstrates the potential of the Omni-Mesoscope in characterizing cellular responses to chemotherapy and chemoresistance. By capturing specific dynamic events over a large cell population, this mesoscale quantitative phase imaging system reveals dynamic subcellular changes along with their underlying molecular characteristics, marking an advancement in in cell biology research. Detailed live-cell imaging and molecular profiling provide a comprehensive understanding of cellular responses to 5-FU treatment. The identification of a subset of SW480 cells exhibiting rapid movements and significant DNA damage highlights the potential of the Omni-Mesoscope in providing the functional interpretation of specific dynamic cell behaviors. The markedly increased cell mobility could be one enabling capability for those cells to eventually detach from the substrate and undergo apoptosis.

In addition, the Omni-Mesoscope facilitates direct observation of cell cannibalism and cell fusion in the formation of polyploid cells in drug-resistant cancer cells, all within a single FOV. Such dynamic events are then correlated with the molecular traits characteristic of highly aggressive cancer cells such as increased stemness, proliferation, and mobility. Consequently, the integration of mesoscale quantitative phase imaging of cell dynamics together with high-content molecular profiling at sub-micrometer resolution significantly enhances the ability to dissect the heterogeneity of cellular responses to therapeutic agents and opens new possibilities to probe the complex interplay between cellular dynamics and molecular mechanisms in real time over a large cell population. The introduction of expansion microscopy within the imaging workflow further enables 3D volumetric super-resolution imaging of thick tissue samples. The Omni-Mesoscope, when coupled with expansion microscopy, shows significantly improved image resolution and 3D sectioning capability on thick tissue sections. It also addresses a bottleneck in imaging throughput for 3D imaging of cleared and expanded samples.

Thus, the Omni-Mesoscope, with its integration of quantitative phase microscopy and highly multiplex fluorescence imaging, presents a significant advancement in the ability to simultaneously capture and analyze the dynamic and molecular essence of cells in high detail and high molecular content.

The present disclosure has described one or more preferred embodiments. However, the invention has been presented by way of illustration and is not intended to be limited to the disclosed embodiments. It should be appreciated that many equivalents, alternatives, variations, and modifications, aside from those expressly stated, are possible and within the scope of the invention.

What is claimed is:

1. A mesoscope, comprising:
a light source configured to generate an illumination light;
an optical system configured to direct the illumination light toward a sample;
an objective lens having a numerical aperture (NA) of 0.2 to 0.6, the objective lens being configured to receive a response light emitted by the sample in response to the illumination light;
a filter wheel comprising a plurality of emission filters configured to filter the response light to generate a filtered light;
a tube lens configured to provide an optical magnification to the filtered light; and
an image sensor having 40 megapixels or more and a pixel size of less than or equal to 4 μm, the image sensor being configured to receive the filtered light and generate image data based on the received filtered light.

2. The mesoscope of claim 1, wherein the optical system is configured to direct the illumination light toward the sample at an angle relative to a surface of the sample that is greater than a maximum collection angle of the objective lens.

3. The mesoscope of claim 1, wherein the light source includes a plurality of light emitting elements optically coupled to the optical system, respective ones of the light emitting elements being configured to output at a different peak wavelength.

4. The mesoscope of claim 3, wherein the light source further includes a plurality of dichroic mirrors configured to combine the outputs of the plurality of light emitting elements.

5. The mesoscope according to claim 1, wherein the optical system includes a multimode fiber and a vibration motor configured to vibrate the multimode fiber.

6. The mesoscope of claim 1, wherein the plurality of emission filters is a plurality of band-pass filters respectively corresponding to different pass bands.

7. The mesoscope of claim 1, further comprising a controller configured to receive the image data from the image sensor and to process the image data.

8. The mesoscope of claim 7, wherein the controller is configured to process the image data by performing at least one of a flat-field calibration operation, a region-wise refocusing operation, or a background reduction, denoising, and deconvolution operation.

9. The mesoscope of claim 1, wherein the image data corresponds to a label-free quantitative phase image.

10. The mesoscope of claim 1, wherein the image data corresponds to a highly multiplexed fluorescence image.

11. The mesoscope of claim 1, further comprising a servo motor configured to control a rotational orientation of the filter wheel.

12. The mesoscope of claim 1, wherein the sample is a biological sample.

13. The mesoscope of claim 12, wherein the biological sample includes a cancer cell.

14. The mesoscope of claim 13, wherein the biological sample has been subjected to a physical expansion operation.

15. An imaging method, comprising:
capturing image data using a mesoscope, the mesoscope including:
a light source configured to generate an illumination light,
an optical system configured to direct the illumination light toward a sample,
an objective lens having a numerical aperture (NA) of 0.2 to 0.6, the objective lens being configured to receive a response light emitted by the sample in response to the illumination light,
a filter wheel comprising a plurality of emission filters configured to filter the response light to generate a filtered light,
a tube lens configured to provide an optical magnification to the filtered light, and
an image sensor having 40 megapixels or more and a pixel size of less than or equal to 4 μm, the image sensor being configured to receive the filtered light and generate image data based on the received filtered light; and
transmitting the image data to a controller, the controller including a processor and a memory.

16. The imaging method of claim 15, further comprising:
performing an image processing operation on the image data by the controller, the image processing operation including at least one of a flat-field calibration operation, a region-wise refocusing operation, or a background reduction, denoising, and deconvolution operation.

17. The imaging method of claim 15, wherein the image data corresponds to a quantitative phase image.

18. The imaging method of claim 15, wherein the image data corresponds to a highly multiplexed fluorescence image.

19. The imaging method of claim 15, wherein the sample is a biological sample.

20. The imaging method of claim 19, further comprising:
prior to capturing the image data, physically expanding the biological sample.
